(19) United States
(12) Patent Application Publication
(10) Pub. No.: US 2004/0086698 A1
(43) Pub. Date: May 6, 2004

(54) Method and apparatus for the application and control of a continuous or intermittent tail seal

(76) Inventors: Robert H. Collins, Aiken, SC (US); Robert M. Heil, Martinez, GA (US)

Correspondence Address: Bernard S. Klosowski, Jr., Dority & Manning, Attorneys at Law, P.A., P.O. Box 1449, Greenville, SC, 29602, US

(21) Appl. No.: 10/285,326

(22) Filed: Oct. 31, 2002

(51) Int. Cl. B32B 31/00

(52) U.S. Cl. 428/220; 156/64; 156/187; 156/450; 156/358; 156/578; 242/160.4

(57) ABSTRACT

A method and apparatus for sealing a tail of a log of web material is provided. A linear tail seal system includes a track and electromagnets that cooperate to move a linear motor. The tail of the log is detected by an electronic eye as the log moves near the linear tail seal system, which signals an adhesive applicator to apply an adhesive to the log. An ironing roll forms a tail seal by adhesively ironing the tail seal on the log. A process for making a roll having a well defined handle formed by the linear tail seal system is also provided.

### BACKGROUND OF THE INVENTION

In the manufacture of rolled web products, a winder winds a web of material to form a large parent roll. The parent roll is subsequently unwound, subjected to a variety of conversions such as embossing, and then re-wound by a rewinder into a consumer-diameter size log. The log is eventually cut into consumer-width size rolls, such as bath tissue, paper towels, and similar finished products. Typically, the finished products are provided with a “handle” which a consumer grasps to initially use the roll.

To form the handle, a conventional tail seal system partially seals an end portion or “tail” of the log upon itself by spraying an adhesive such as glue on the log. The log and tail are then sealed together and cut into the consumer-width size rolls, each having a handle formed from a section of sealed tail. Typically, the conventional spray tail seal system utilizes multiple, high-pressure spray nozzles, or heads, that are stationary relative to the log. These nozzles inaccurately apply the adhesive and often completely tack the tail to the log. With the tail completely tacked-down, no handle is provided on the finished rolls, which is unsatisfactory to the consumer.

### BRIEF SUMMARY OF THE INVENTION

In general, the present invention provides a linear tail seal system and a method of using the linear tail seal system for sealing a tail on a log of web material. The linear tail seal system produces a well-defined tail seal that creates the desired handle on a finished rolled product. The component parts of the invention are simple, reliable, and economical to manufacture and use. Other aspects and advantages of the invention will be apparent from the following description and the attached drawings, or can be learned through practice of the invention.

In one aspect of the invention, the linear tail seal system includes a linear tail seal assembly having a linear motor, a track, and a magnet. The linear motor is movably attached to the track, which is transversely positioned relative to the log. The magnet is located near the track to electromagnetically move the linear motor along the track to traverse the log. An applicator is attached to the linear motor to apply an adhesive to a portion of the log, such as the tail, as the linear motor and applicator conjointly move. The tail is ironed to the log to seal the tail. Eventually, the log and sealed tail are cut into consumer-size rolls, each having a handle for initial use of the roll.

In another aspect of the invention, a method for sealing the tail of the log of web material is provided. The method includes a linear tail seal system similar to the foregoing aspect in which the linear tail seal system has a motor and adhesive applicator located near a winder and a track. The motor and adhesive applicator traverse the log by moving along the track located near the log. An electronic photographic eye senses the position of the tail as the motor and adhesive applicator move. Once the tail is sensed, the adhesive is applied to the log, its tail, or both, and the tail is adhesively pressed to the log by a press or ironing roll to form the tail seal. Finally, the log is cut into rolls with well-defined handles and packaged for sale to consumers.

In a further aspect, a process for producing a roll with a well-defined handle is disclosed. The steps of the process include, for example:

providing a linear tail seal system disposed proximate a winder configured for forming a log of web material, the linear tail system having an adhesive applicator, a magnet and a track disposed transverse to the log;

rotating the log such that a tail of the log depends in a direction of the linear tail seal system;

propelling the adhesive applicator linearly along the track via the magnet to traverse the log to apply an adhesive;

spraying the adhesive from the adhesive applicator to form a tail seal on the log as the adhesive applicator linearly traverses the log; and

separating the tail-sealed log into a plurality of rolls having handles configured to be grasped by for initial use of the plurality of rolls.

### BRIEF DESCRIPTION OF THE DRAWINGS

The above and other aspects and advantages of the present invention are apparent from the detailed description below and in combination with the drawings in which:

FIG. 1 is a side view of a linear tail seal system in accordance with an aspect of the invention;

FIG. 2 is a partial end-on view of the linear tail seal system;

FIG. 3 is a perspective view of a linear tail seal assembly used in the tail seal system of FIG. 1;

FIG. 4 is a perspective view of a log defining a tail used to form a finished product with a handle in accordance with another aspect of the invention; and

FIG. 5 is a histogram illustrating roll handle lengths produced by the linear tail system.

Repeat use of reference characters in the drawings and the detailed description is intended to represent same or analogous features or elements of the invention.

### DETAILED DESCRIPTION OF THE DRAWINGS

Detailed reference will now be made to the drawings in which examples embodying the present invention are shown. The drawings and detailed description provide a full and detailed written description of the invention and the manner and process of making and using it, so as to enable one skilled in the pertinent art to make and use it. The drawings and detailed description also provide the best mode of carrying out the invention. However, the examples set forth herein are provided by way of explanation of the invention and are not meant as limitations of the invention. The present invention thus includes modifications and variations of the following examples as come within the scope of the appended Claims and their equivalents.

The Figures generally show a linear tail seal system 10 which linearly applies an adhesive 26 to a log 14a that has been formed from a web material 16. The adhesive 26 can be a glue, a heat-activated glue substance, paste, adhesive blends, epoxy, epoxy resins, mucilage or similar products, such as National 18-346a adhesive available from National Starch and Chemical Company, Berkeley, Calif. By way of example, the web material 16 is a paper used to make tissue, paper towels, or the like. However, the web material 16 is not limited to paper. Web material 16 can be a non-woven polymer material, an airlaid material, a wet material, a dry material, a treated material, a disposable material, any combination of the foregoing, and/or any other material that utilizes tail seals.

The linear tail seal system 10 generally includes a linear tail seal assembly 28 with a track (rail) 30, a linear motor 34, and a magnet 36. The linear motor 34 is movably attached to the track 30, which is disposed transverse to the log 14a. The relative arrangement of the track 30, the linear motor 34 and the magnet 36 permits the linear motor 34 to electromagnetically move along the track 30 to traverse a length of the log 14a, as will be described in greater detail below.

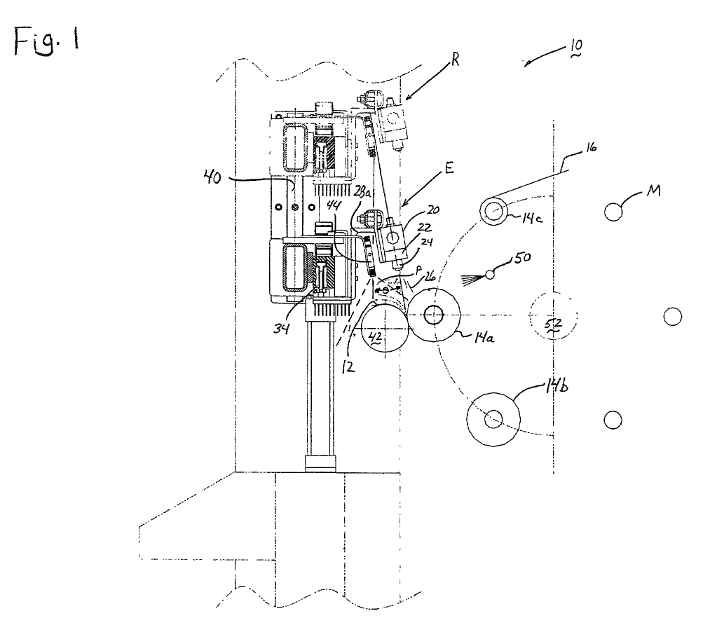

Referring to FIG. 1, there is shown a side view of one embodiment of the tail seal system 10 in which a sprayer 20 is attached to the linear motor 34. The sprayer 20 traverses the log 14a with the linear motor 34 to apply the adhesive 26. Sprayer 20 includes a separate glue head 22 and a spray tip 24 for applying the adhesive 26. Therefore, the glue head 22 and spray tip 24 can be replaced with similar components to replace worn components or to change, for example, a spray pattern, discussed below. Although only one sprayer 20 is shown in FIG. 1, it within the scope of the invention to use two or more sprayers 20, discussed in detail below. Further, it is to be noted that the terms “sprayer”, “gun”, and “applicator” may be used interchangeably to describe sprayer 20.

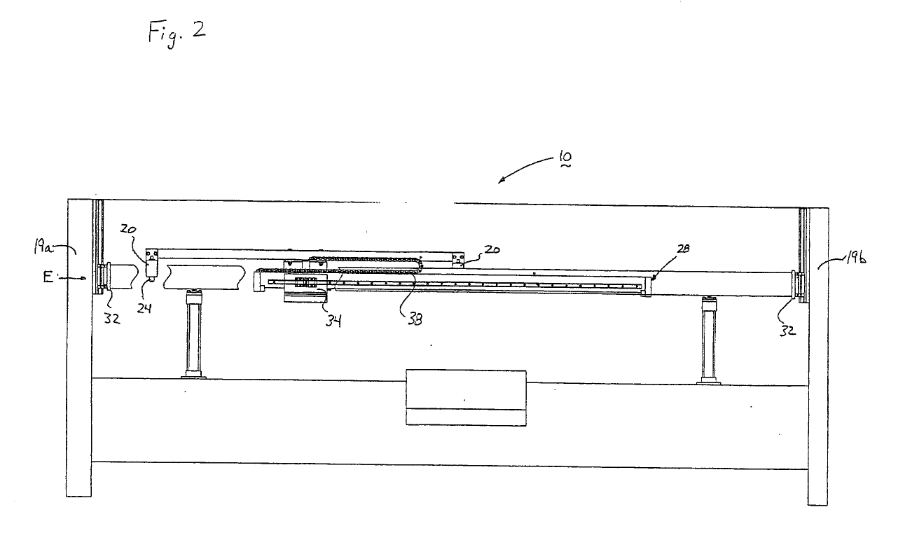

As FIG. 2 generally shows, the linear tail seal assembly 28 is disposed between frames 19a and 19b in an end-on view of the foregoing embodiment. FIG. 2 illustrates that the inventive arrangement does not require a costly servo-gearbox-actuator arrangement as used in previous designs. More specifically, the linear tail seal assembly 28 and its linear motor 34 are compact enough to fit and move laterally within the frames 19a and 19b, as limited by failsafe stops 32. By way of example, Trilogy Systems, located in Webster, Tex., provides a Linear Servo Motor™, which is cost effective, simple in design, and suitable for use as the linear motor 34.

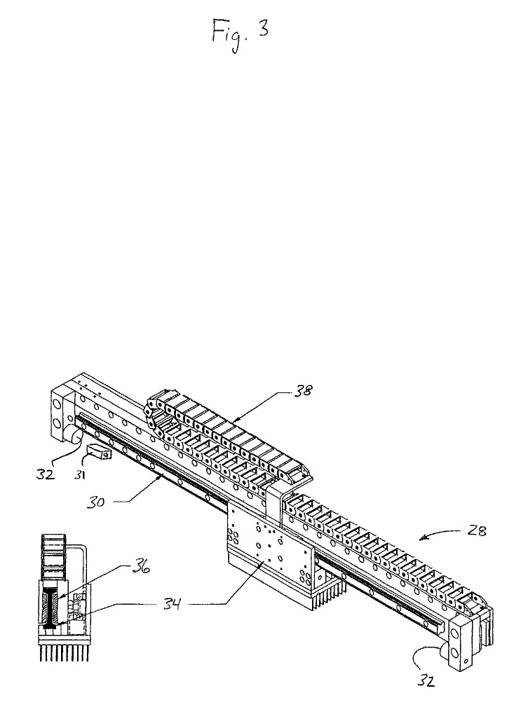

FIG. 3 shows the linear tail seal assembly 28 in greater detail. In this aspect of the invention, the linear motor 34 operates on the track 30 centered between two rows of magnets 36 (see FIG. 3 inset). In this example, the magnets 36 are rare earth magnets that interact with the linear motor 34 to cause the linear motor 34 to ride along the track 30. This operation is essentially the same concept as a rotary motor laid flat. The coils (not shown) in the motor 34 respond to the rare earth magnets 36 to propel the motor 34 along the track 30 through electromagnetic interaction. The only mechanical contact occurs between the linear bearing (not shown) and the track 30. Thus, this electromagnetic arrangement is reliable, wear resistant, fast, and accurate. Since electromagnetic interaction is known, further details need not be given to appreciate this aspect of the invention.

FIG. 3 further shows a flexible cable tray or chain 38 located where the electrical wires (not shown) for the linear motor 34 and the glue heads 22 are routed. Additionally, a hydraulic-type hose (not shown) for transporting adhesive 26 is arranged via this flexible cable tray 38. The cable tray 38 keeps these various wires and hoses bundled together and confined to a space to follow the motor 34 and prevent tangling. Also shown, a proximity sensor 31 and the failsafe stops 32, such as rubber bumpers or similar devices, prevent the linear motor 34 and sprayer 20 from exceeding the limits of the track 30 during linear operation. More specifically, the proximity sensor 31 is used to limit movement of the linear motor 34 by signaling a starting or home position. The proximity sensor 31 may be located near the rubber stop 32 as shown, attached to the linear motor 34, or positioned in other appropriate monitoring areas about the linear tail seal assembly 28. Furthermore, a plurality of proximity sensors 31 may be positioned about the linear tail seal assembly 28 to cooperably signal the home position of the linear motor 34. Also, mechanical devices (not shown) may be used in addition to or in lieu of one or both the proximity sensor 31 and the failsafe stop 32 to maintain the linear motor 34 within limits of the track 30.

Referring with more particular reference to FIG. 1, the sprayer 20 is shown in an engaged position E proximate the log 14a (a disengaged or retracted position R is illustrated in phantom). The sprayer 20 is physically attached to the linear motor 34 by, for example, an aluminum arm 28a. Since the sprayer 20 is attached to the linear motor 34, the sprayer 20 moves with the linear motor 34 via the electromagnetic interaction described above. In conjunction with a supplied computer/controller, software, and driver module (not shown), stop and start positions, speed, and acceleration/deceleration rates of the linear motor 34 can be changed with great accuracy, even during operation of the linear tail seal system 10. For example, the software provides variable position control of the motor 34 to within 5 microns. The present invention thus permits controlled log traversal and targeted application of the adhesive 26. In contrast, conventional tail seal systems were designed to operate on a continuous low-speed velocity profile and apply adhesive in a less precise manner from a stationary position.

Consideration has also been made for tail seal system 10 operators to manually control the tail seal assembly 28 during a perforation (“perf”) phase, a cut-off phase, or when the log 14c is “in thread”. Older winders do not permit such real-time transfers without manual assistance. In the present invention, operators can choose to disable the tail seal assembly 28 or it will automatically disengage when the perforation head (not shown) is up. When the tail seal assembly 28 is disabled or when the perforation head is disengaged, the tail seal assembly 28 is retracted approximately 10 inches above the log 14a (see retracted position R in FIG. 1). The retracted position R provides ample access to the logs 14a, b, c at their transfer positions. By way of example, when perforation heads are reengaged by an operator, the tail seal assembly 28 returns to the engaged position E as seen in FIG. 1 to continue application of adhesive 26.

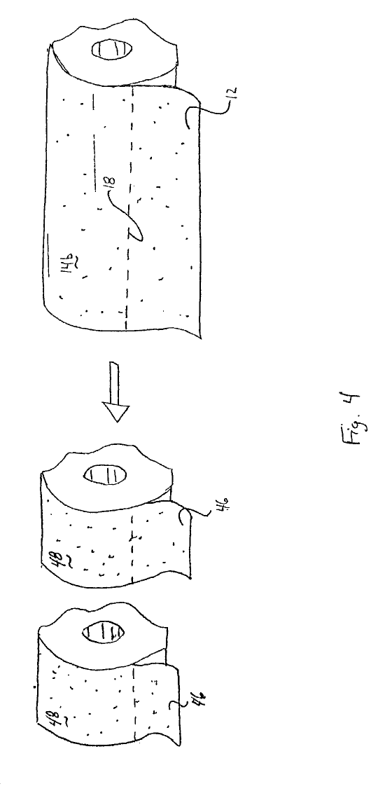

Also shown in the example in FIG. 1, the sprayer 20 includes the glue head 22 with the spray tip 24, briefly introduced above. These components are arranged to precisely apply the adhesive 26 to the tail 12 of log 14a. For example, the spray tip 24 is configured to apply the adhesive 26 to the log 14a in a flat spray pattern to produce a well-defined tail seal 18 (see FIG. 4). It is to be noted, however, that the spray tip 24 can be selected to apply various other spray patterns or bead patterns as desired.

A Spraymation® 79224 Electromatic XV sprayer, available from Spraymation, Inc. of Ft. Lauderdale, Fla., is suitable for use as the sprayer 20. A suitable spray tip 24 is the Spraymation® 490650-45 spray tip, which has a 0.015 inch orifice size and a 25° flat spray projection. While comparable spray tips from other suppliers can be substituted, a compact spray pattern as described is desirable to achieve the well-defined flat spray pattern. This well-defined pattern reduces both adhesive and log waste in conjunction with inventive start-stop sequencing and “zipper” patterning, described below.

FIG. 1 further illustrates the spray tip 24 located above the log 14a in the engaged position E at approximately 3 inches and angled toward the log 14a at about 15° to 20° from vertical, indicated by the symbol θ. The sprayer 20 applies the adhesive 26 when an electronic tail detect photographic eye 44 (hereinafter photo eye 44) senses a position of the tail 12. Once the position of tail 12 is sensed, the adhesive 26 is applied. It is to be noted that alternative sensors can be used in place of the photo eye 44. For instance, mechanical, infrared, and/or timing sensor devices may be used in addition to or in place of the photo eye 44.

In known tail seal systems, adhesive is applied at upwards of 2000 pounds per square inch (psi), which can contribute to poorly applied adhesives. The present sprayer 20 can also apply adhesive 26 at between 0 psi to about 2000 psi, but 20 to 400 psi is advantageously used. The lower pressure range is more controllable and thus, safer and reduces adhesive waste.

Also seen in FIG. 1, by orienting the spray tip 24 from the log 14a as described above, less adhesive 26 is applied to the outside of a finished log 14c. The controllable, targeted adhesive application as shown results in the well-defined tail seal 18. (Consider FIG. 4). Moreover, by “zippering” the tail seal 18, consumption of adhesive 26 is further reduced. A zippered tail seal 18 is formed by intermittently shutting the adhesive 26 on and off as the sprayer 20 traverses the log 14a. In this example, the adhesive 26 is nominally applied directly on the log 14a, but it will be appreciated that the adhesive 26 can be applied to the tail 12 or to both the tail 12 and log 14a. In any case, adhesive add-on of only 6.2 plus or minus 0.60 grams of adhesive 26 per log 14a results from the foregoing arrangement. Adhesive consumption is therefore reduced by as much as 50% over the prior art. Therefore, by combining zippering with the start-stop capability of the linear motor 34, described above, add-on rates of adhesive 26 are significantly reduced without compromising quality.

FIG. 1 further shows a servo-controlled ironing roll 42 movably arranged near the log 14a. Special control features are provided to precisely start and stop of the ironing roll 42. More particularly, to allow the sprayer 20 and linear motor 34 to traverse the log 14a to apply adhesive 26, the ironing roll 42 must be started and stopped accurately with each log 14a. This is accomplished by coupling the ironing roll 42 with the photo eye 44. In operation, for example, when the photo eye 44 flags the tail 12, the ironing roll 42 pauses or stops rotation and the adhesive 26 is applied by the traversing sprayer 20. Once the linear motor 34 and sprayer 20 have completed their travel, the ironing roll 42 begins rotation again to seal the tail 12 onto the log 14a.

In a further inventive arrangement, the servo-controlled ironing roll 42 is provided with a two-stage, high-speed/low-speed velocity control profile with variable, high-speed duration, velocity profiles which are functions of various speeds of the linear tail seal system 10. The two-stage speed profile achieved by the ironing roll 42 allows the log 14a to be ironed at various revolutions per minute (rpm) based on system speeds. Variable rpm's as functions of the various mandrel M positions of a winder 52 are also supplied.

By way of example, if the photo eye 44 belatedly detects the tail 12 entering a predetermined position P (indicated by dashed lines in FIG. 1), the ironing roll 42 will subsequently increase to its high-speed profile after the adhesive 26 is applied. In this way, the log 14a can still be ironed even if the winder 52 is “behind schedule”. This flexibility avoids culling logs 14a and therefore, reduces waste and associated costs. However, if the mandrel M and log 14a advance to position P past a predetermined time, the tail 12 is “missed” and the log 14a is culled, as it is assumed that the log 14a exceeds the limits of position P for proper adhesive application.

As shown in FIG. 2, it will be appreciated that the tail seal system 10 may include multiple sprayers 20 disposed generally in opposite directions along the track 30. In this aspect, each sprayer 20 will apply adhesive 26 to selected portions of the log 14a. Alternatively, two linear motors 34 having two or more sprayers 20 attached at opposite ends of track 30 may linearly traverse the log 14a from a respective stop 32 toward a center of the linear tail seal assembly 28 until the two linear motors 34 meet or approach one another. Afterwards, the linear motors 34 return to starting positions near the stops 32 for subsequent applications of adhesive 26 on subsequent logs 14a.

It is to be noted that the linear motor 34 may make one linear pass per log 14a. For instance, the linear motor 34 and sprayer(s) 20 will make one traversal of one log 14a while applying adhesive 26 and then stop proximate the proximity sensor 31 while another log 14a is indexed or positioned as seen in FIG. 1. Subsequently, the linear motor 34 and sprayer 20 traverse the newly indexed log 14a in a return direction along track 30. In this manner, logs 14a are adhesively treated rapidly and wear and tear can be reduced on the linear tail seal assembly 28.

FIG. 4 shows the finished log 14b with tail seal 18. Also shown is a resultant finished product or rolls 48 with well-defined handles 46 for the consumer to grasp to begin use of the rolls 48. The illustrated handles 46 comply with consumer requirements in contrast to ill-defined handles produced by some known tail seal systems. As introduced, conventional, stationary, multiple spray head systems are inaccurate and often tack handles completely to rolls. In contrast, the inventive roll handle lengths 46 fall within the middle 80% range of a target length from 90% to 98% of the time. For example, if the target length is 6 millimeters (mm) to 8 mm, the handle length 46 will be 6.4 mm to 7.6 mm 90-98% of the time.

A real-world example of the present invention's handle 46 accuracy is provided below. This example is based on a test run, which required finished rolls 48 to have target handle lengths between 5 mm to 50 mm. It is to be understood that these stated handle 46 lengths are examples only to illustrate repeatability and accuracy of the invention and are not intended to limit the invention to these handle 46 lengths.

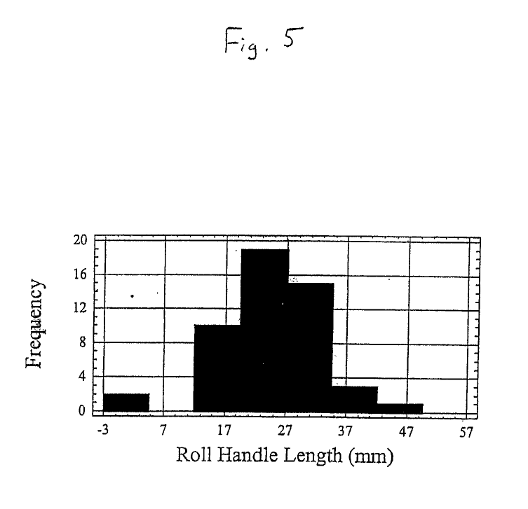

As seen in the histogram of FIG. 5, fifty rolls 48 produced in accordance with an aspect of the invention were gathered at a rate of one cut roll 48 per log 14b and randomly measured. The histogram reveals that of the population of fifty handle 46 measurements, only 4% of the sample handles 46 were below the lower specification limit of 5 mm. This is a significant improvement over handle lengths created from some known tail seal systems. Significantly, the bulk of the sample handles 46 appeared within the following range: 19<×<31 mm. The average handle length was 24.66 mm with a standard deviation of 8.29 mm.

A method for forming rolls 48 from the log 14b is described below.

As shown most clearly in FIG. 1, the linear tail seal system 10 is disposed proximate a winder 52 to traverse the log 14a. The linear tail seal system 10 is configured to linearly traverse the log 14a to apply the adhesive 26. Initially, after log 14a is formed, the log 14a is rotated such that the tail 12 depends in a direction of the linear tail seal system 10. The method includes sensing a position of the tail 12 to adjust the rotation of the log 14a when the tail 12 is disposed in a direction of the linear tail seal system 10. The sensing step further includes stopping the rotation of the log 14a when the log is disposed within 10° to about 30° of the linear tail seal system 10.

To apply the adhesive 26, the linear motor 34 and sprayer 20 are propelled along the track 30. The adhesive 26 is applied to form the tail seal 18 as the sprayer 20 linearly traverses the log 14a along the track 30. The tail seal 18 can be formed by applying adhesive 26 intermittently in a zippered pattern by shutting the sprayer 20 on and off as the sprayer 20 linearly traverses the log 14a along the track 30. Alternatively, the adhesive 26 can be applied continuously in a flat spray pattern.

Also in this aspect of the invention, a plurality of air blasts 50 may be provided to manipulate the tail 12. Operation of the air blasts 50 includes essentially the tail 12 being blown open as the tail 12 rotates past the sprayer 20. Specifically, as the photo eye 44 in this aspect senses the tail 12, the air blast 50 seen in FIG. 1 blows the tail 12 down onto the ironing roll 42 and the adhesive 26 is applied.

The method further includes the step of retracting the linear tail seal assembly 28 away from the log 14a prior to the log 14a being rotated away as a finished log 14b. Retraction of the linear tail seal assembly 28 may be accomplished substantially vertically as illustrated in FIG. 1, although any direction away from log 14a is contemplated by the invention.

While preferred embodiments of the invention have been shown and described, those skilled in the art will recognize that other changes and modifications may be made to the foregoing embodiments without departing from the scope and spirit of the invention. For example, specific shapes of various elements of the illustrated embodiments may be altered to suit particular applications. It is intended to claim all such changes and modifications as fall within the scope of the appended claims and their equivalents.

That which is claimed is:

1. A method for sealing a tail of a log of web material disposed on a winder, the method comprising the steps of:
a) providing a linear tail seal system disposed proximate the winder, the linear tail seal system having a track disposed transverse to the log, an applicator of the linear tail seal system configured to linearly traverse the log via the track;
b) rotating the log such that the tail depends in a direction of the linear tail seal system;
c) propelling the applicator of the linear tail seal system along the track;
and
d) applying an adhesive from the applicator to form a tail seal as the applicator linearly traverses the log along the track.

2. The method as in claim 1, wherein the adhesive is applied by the applicator to the log.

3. The method as in claim 1, wherein the adhesive is applied by the applicator to the tail.

4. The method as in claim 1, wherein the applicator includes a spray tip configured to apply the adhesive in a flat spray pattern.

5. The method as in claim 1, wherein the adhesive is selected from the group consisting of a glue, a paste, an adhesive blend, an epoxy, an epoxy resin, a mucilage and combinations thereof.

6. The method as in claim 1, further comprising the step of sensing a position of the tail to adjust the rotation of the log when the tail is disposed in the direction of the linear tail seal system.

7. The method as in claim 6, wherein the step of sensing the position of the tail includes stopping the rotation of the ironing roll.

8. The method as in claim 6, wherein the position of the tail is sensed by a tail detect photographic eye.

9. The method as in claim 1, further comprising the substep of intermittently shutting the adhesive on and off as the applicator linearly traverses the log along the track.

10. The method as in claim 1, wherein the adhesive is applied at between 20 pounds per square inch to about 2000 pounds per square inch.

11. The method as in claim 1, wherein the applicator is electromagnetically propelled along the track.

12. The method as in claim 11, wherein the track is disposed proximate a magnet.

13. The method as in claim 11, wherein the track is interposed between a plurality of rare earth magnets.

14. The method as in claim 11, further comprising a linear motor, the part attached to the linear motor, the linear motor configured to be electromagnetically propelled along the track.

15. The method as in claim 14, wherein the linear motor is configured for adjustable and variable speeds.

16. The method as in claim 1, further comprising the step of ironing the log with an ironing roll to form the tail seal.

17. The method as in claim 16, wherein the ironing roll includes a servomechanism configured to provide the ironing roll with a two-stage speed profile to iron the roll at multiple revolutions per minute.

18. The method as in claim 1, further comprising the step of emitting an air blast by at least one air blast to direct the tail in the direction of the linear tail seal system.

19. The method as in claim 1, further comprising the step of retracting the linear tail seal system away from the log.

20. The method as in claim 19, wherein the linear tail seal system is retracted substantially vertically.

21. The method of claim 1, further comprising the substeps of applying an axial stripe of adhesive to a portion of the log, pressing the stripe against the log, and ejecting the tail-sealed log away from the linear tail seal system.

22. The method of claim 1, wherein the adhesive is applied by at least two electronic glue guns disposed at opposite ends of the linear tail seal system, the at least two electronic glue guns configured to apply the adhesive to predetermined portions of the log.

23. The method of claim 1, further comprising the step of separating the tailsealed log into a plurality of rolls having handles configured to be grasped by consumer upon initial use of the rolls.

24. A linear tail seal system for sealing a tail of a log of web material, the linear tail seal system comprising:
a linear tail seal assembly having a motor, a track, and a magnet, the motor movably attached to the track, the track disposed transverse to the log, the magnet disposed proximate the track, the motor and the magnet cooperable to move the motor along the track to traverse the log; and
an applicator attached to the motor and configured to traverse the log with the motor to apply an adhesive.

25. The linear tail seal system of claim 24, wherein the magnet is a plurality of rare earth magnets configured to electromagnetically propel the motor along the track.

26. The linear tail seal system of claim 24, wherein the applicator is at least two electronic sprayers disposed at opposing ends of the track and configured to apply the adhesive to selected portions of the log.

27. The linear tail seal system of claim 24, wherein the applicator includes a spray tip configured to apply the adhesive in a flat spray pattern.

28. The linear tail seal system of claim 24, wherein the applicator is configured to be intermittently shut on and off as the linear tail seal system linearly traverses the log along the track such that the adhesive is applied intermittently.

29. The linear tail seal system of claim 24, wherein the applicator is configured to apply the adhesive at between 20 pounds per square inch to about 2000 pounds per square inch.

30. The linear tail seal system of claim 24, further comprising an ironing roll configured to iron the log and form the tail seal.

31. The linear tail seal system of claim 24, further comprising an tail detect photo eye configured to sense a position of the tail.

32. The linear tail seal system of claim 31, wherein the tail detect photo eye is configured to electronically control a movement of the ironing roll.

33. A roll with a handle configured to be grasped for initial use of the roll, the handle having a length which falls within a middle 80% of a target length from between 90% to about 98% of the time, the roll made by the process comprising the steps of:
a) providing a linear tail seal system disposed proximate a winder configured for forming a log of web material, the linear tail system having an adhesive applicator, a magnet and a track disposed transverse to the log;
b) rotating the log such that a tail of the log depends in a direction of the linear tail seal system;
c) propelling the adhesive applicator linearly along the track via the magnet to traverse the log to apply an adhesive; and
d) spraying the adhesive from the adhesive applicator to form a tail seal on the log as the adhesive applicator linearly traverses the log.

34. The roll made by the process of claim 33, wherein the web material is selected from the group consisting of a paper, a tissue, a non-woven polymer material, an airlaid material, a wet material, a dry material, a treated material, a disposable material, and combinations thereof.

35. The roll made by the process of claim 34, wherein the disposable material is selected from the group consisting of a facial tissue, a paper towel, an industrial wiper, a laboratory wiper, a wet wipe, and combinations thereof.

36. The roll made by the process of claim 33, wherein the magnet is a plurality of rare earth magnets configured to electromagnetically propel a motor along the track, the adhesive applicator attached to the motor.

37. The roll made by the process of claim 33, wherein the adhesive applicator is configured to be intermittently shut on and off as the adhesive applicator linearly traverses the log along the track such that the adhesive is applied intermittently.

38. The roll made by the process of claim 33, further comprising an ironing roll configured to iron the log and form the tail seal after the adhesive is sprayed.

39. The roll made by the process of claim 38, wherein the ironing roll includes a servomechanism configured to provide the ironing roll with a two-stage speed profile to iron the roll at various revolutions per minute.

40. The roll made by the process of claim 38, further comprising the step of separating the tail-sealed log into a plurality of rolls having handles configured to be grasped by for initial use of the plurality of rolls.

41. A plurality of roll products with handles configured to be grasped by consumers, each handle of each of the roll products defining a standard deviation of between 0% to about 20% from a target handle length.

42. The roll product of claim 41, wherein the target handle length is between 5 mm to about 50 mm.

43. The roll product of claim 41, wherein the handles are adhered to the roll product in a zippered adhesive pattern.

44. The roll product of claim 41, wherein the handles are adhered to the roll product in a beaded adhesive pattern.

45. The roll product of claim 41, wherein the handles are adhered to the roll product in a flat spray adhesive pattern.
